(19) United States
(12) Patent Application Publication
(10) Pub. No.: US 2024/0028018 A1
(43) Pub. Date: Jan. 25, 2024

(54) ANALYSIS APPARATUS

(71) Applicant: NEC Corporation, Tokyo (JP)

(72) Inventors: Ryosuke Togawa, Tokyo (JP); Yutaka Takahashi, Tokyo (JP); Shigemasa Yokota, Tokyo (JP)

(73) Assignee: NEC Corporation, Tokyo (JP)

(21) Appl. No.: 18/222,267

(22) Filed: Jul. 14, 2023

(30) Foreign Application Priority Data
Jul. 20, 2022 (JP) 2022-115610

(51) Int. Cl. G05B 23/02

(52) U.S. Cl. CPC G05B 23/0221

(57) ABSTRACT

An analysis apparatus includes: an anomaly classifying unit that classifies the type of an anomaly having occurred based on time-series sensing data in occurrence of anomaly received from a plurality of sensors and a learned model learned in advance; and an identifying unit that identifies a sensor having detected information corresponding to the cause of the anomaly classified by the anomaly classifying unit based on information corresponding to the sensing data and information corresponding to past data that is past sensing data stored in advance.

### INCORPORATION BY REFERENCE

This application is based upon and claims the benefit of priority from Japanese patent application No. 2022-115610, filed on Jul. 20, 2022, the disclosure of which is incorporated herein in its entirety by reference.

### TECHNICAL FIELD

The present invention relates to an analysis apparatus, an analysis method, and a recording medium.

### BACKGROUND ART

There are known techniques used to detect and classify an anomaly based on time-series data acquired from a plurality of sensors.

For example, Patent Literature 1 describes a time-series data processing method that includes generating a generator having learned so as to generate state information representing the state of time-series data having a predetermined time width according to a label assigned to the time-series data, generating state information representing the state of divided time-series data obtained by dividing the time-series data by a time width shorter than the predetermined time width by using the generator, and classifying the divided time-series data based on a plurality of divided time-series data state information.

Further, for example, Patent Literature 2 describes a related technique. Patent Literature 2 describes, for example, a failure prediction method that includes a first generation step of generating a normality model based on normal state part extracted from sensor data of a plurality of sensors installed in mechanical equipment, a second generation step of generating an anomaly classification model based on the normality model, and an evaluation step of evaluating the degree of deviation from the normal state of the mechanical equipment. For example, according to Patent Literature 2, an anomaly pattern is determined based on the value of output of the anomaly classification model obtained by inputting evaluation part extracted from the sensor data into the anomaly classification model when it is determined that there is a sign of failure in the mechanical equipment based on the degree of deviation.
Patent Document 1: WO2020/245980
Patent Document 2: Japanese Unexamined Patent Application Publication No. JP-A 2019-185422

For example, in a case where machine learning with labels as described in Patent Literature 1 is performed, mostly, learning instances are empirically labeled by human hands. As a result, for example, data with the same label may include data of a different sensor behavior, and there is a possibility that labeling is not appropriately performed. Thus, there is a problem that it may be difficult to perform appropriate labeling.

### SUMMARY OF THE INVENTION

Accordingly, an object of the present invention is to provide an analysis apparatus, an analysis method, and a recording medium that solve the abovementioned problem.

In order to achieve the object, an analysis apparatus as an aspect of the present disclosure includes at least one memory configured to store instructions and at least one processor configured execute the instructions to: execute the instructions to: classify a type of an anomaly having occurred based on time-series sensing data in occurrence of anomaly received from a plurality of sensors and a learned model learned in advance; and identify a sensor having detected information corresponding to a cause of the classified anomaly based on information corresponding to the sensing data and information corresponding to past data that is past sensing data stored in advance.

Further, an analysis method as another aspect of the present disclosure is executed by an information processing apparatus, and includes: classifying a type of an anomaly having occurred based on time-series sensing data in occurrence of anomaly received from a plurality of sensors and a learned model learned in advance; and identifying a sensor having detected information corresponding to a cause of the classified anomaly based on information corresponding to the sensing data and information corresponding to past data that is past sensing data stored in advance.

Further, a recording medium as another aspect of the present disclosure is a computer-readable recording medium having a program recorded thereon, and the program includes instructions for causing an information processing apparatus to realize processes to: classify a type of an anomaly having occurred based on time-series sensing data in occurrence of anomaly received from a plurality of sensors and a learned model learned in advance; and identify a sensor having detected information corresponding to a cause of the classified anomaly based on information corresponding to the sensing data and information corresponding to past data that is past sensing data stored in advance.

With the configurations as described above, the abovementioned problem can be solved.

### BRIEF DESCRIPTION OF DRAWINGS

FIG. 1 is a view showing a configuration example of an analysis system in a first example embodiment of the present disclosure;

FIG. 2 is a block diagram showing a configuration example of an analysis apparatus;

FIG. 3 is a view showing an example of information included by learning information;

FIG. 4 is a view showing an example of time-series data;

FIG. 5 is a view showing an example of information included by anomaly model database;

FIG. 6 is a view showing an example of information included by normality model database;

FIG. 7 is a view for describing an example of processing by a model generating unit;

FIG. 8 is a view for describing an example of output by an output unit;

FIG. 9 is a flowchart showing an operation example of the analysis apparatus at the time of learning;

FIG. 10 is a flowchart showing an operation example of the analysis apparatus at the time of analyzing;

FIG. 11 is a view showing another configuration example of the analysis apparatus;

FIG. 12 is a view showing another configuration example of the analysis system;

FIG. 13 is a view showing an example of a hardware configuration of an analysis apparatus in a second example embodiment of the present disclosure; and

FIG. 14 is a block diagram showing a configuration example of the analysis apparatus.

### EXAMPLE EMBODIMENTS

### First Example Embodiment

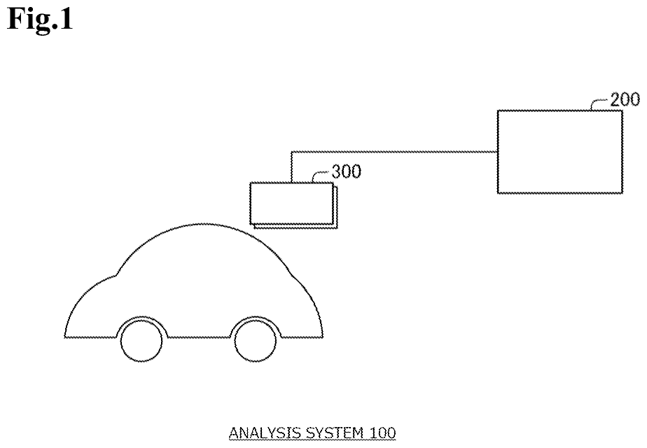

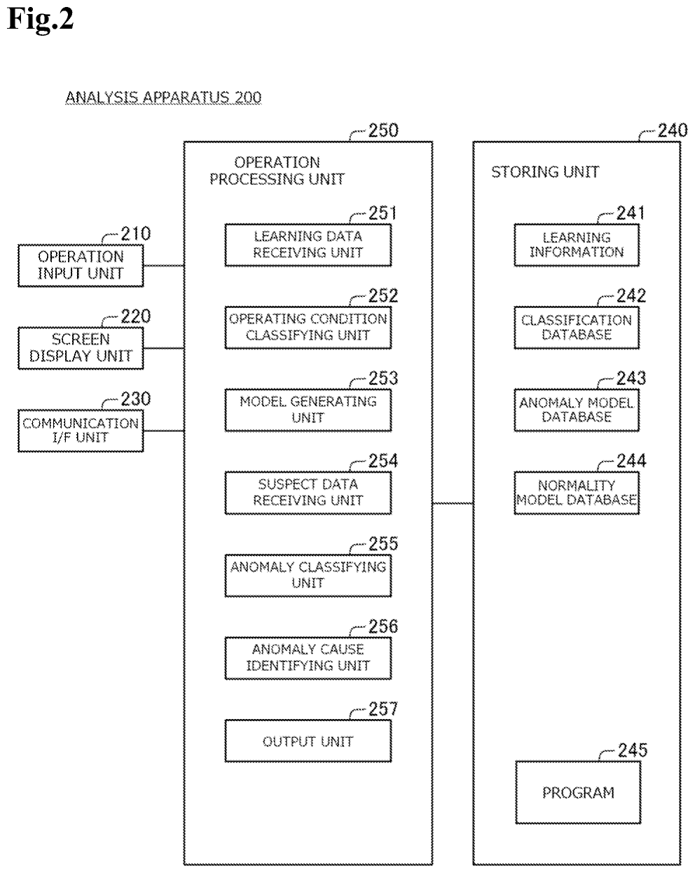

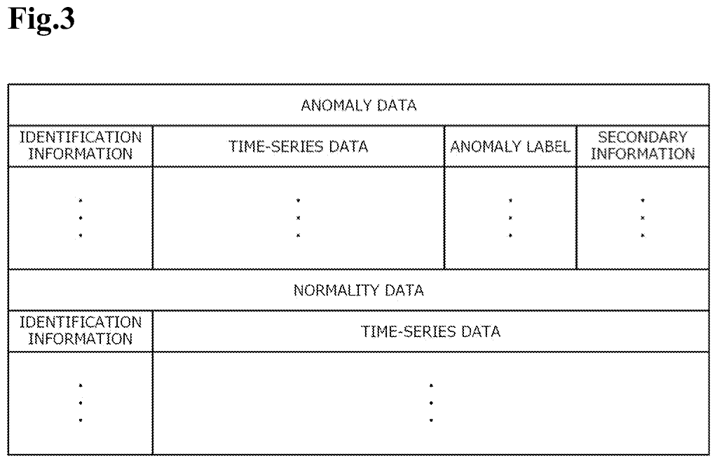

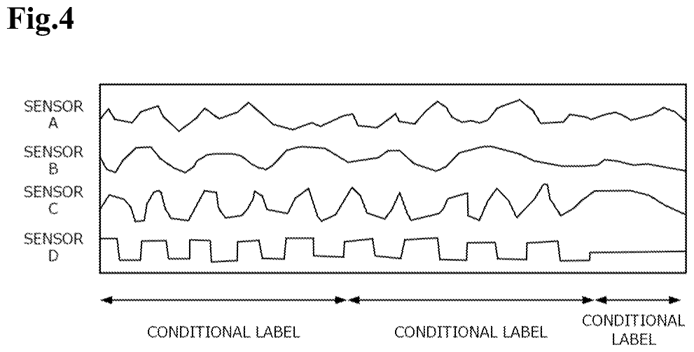

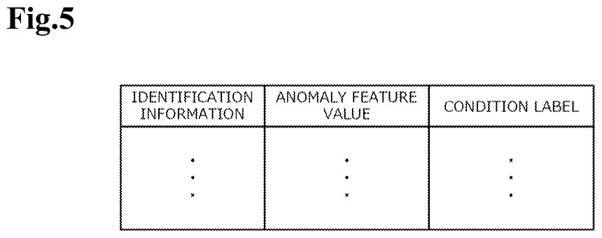

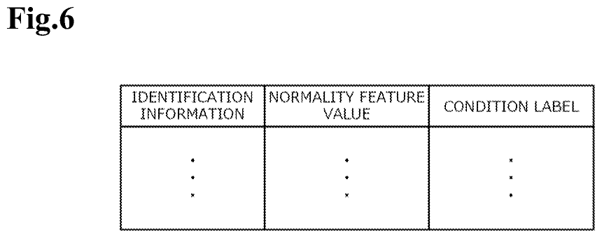

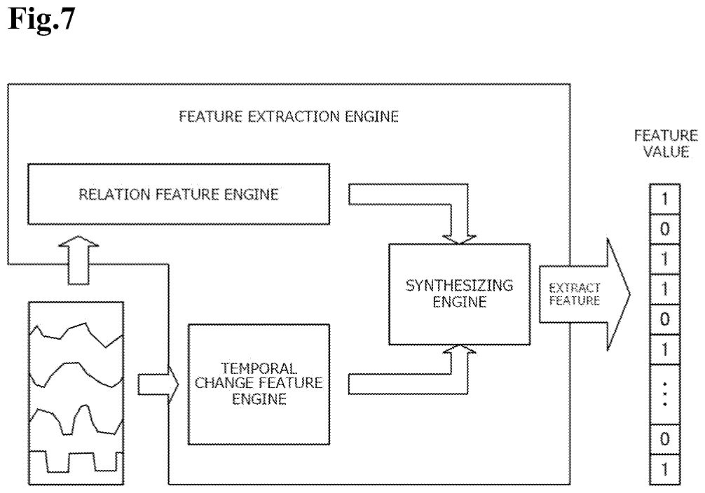

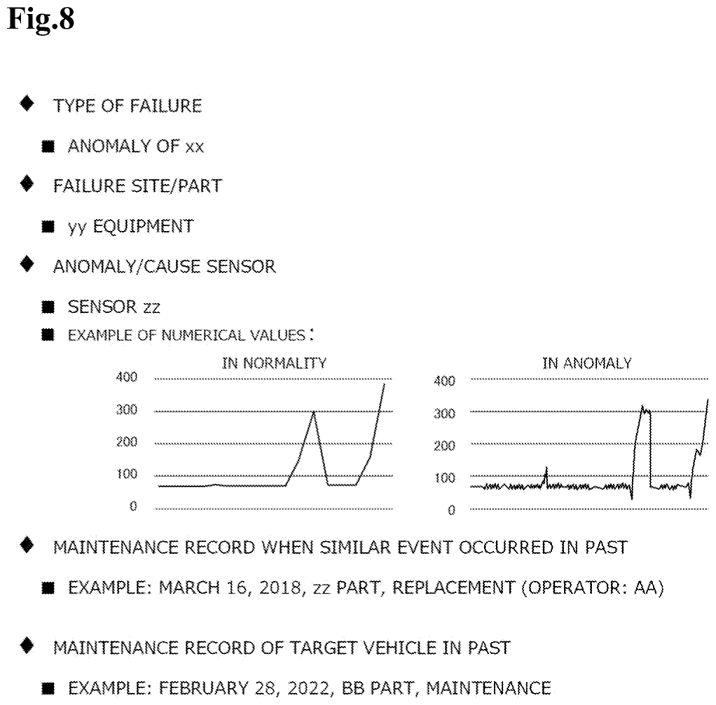

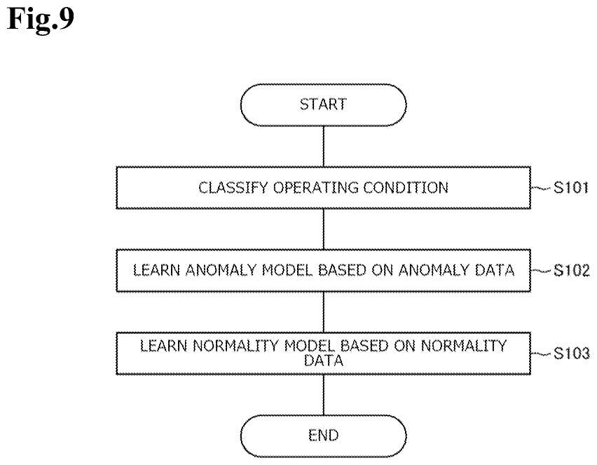

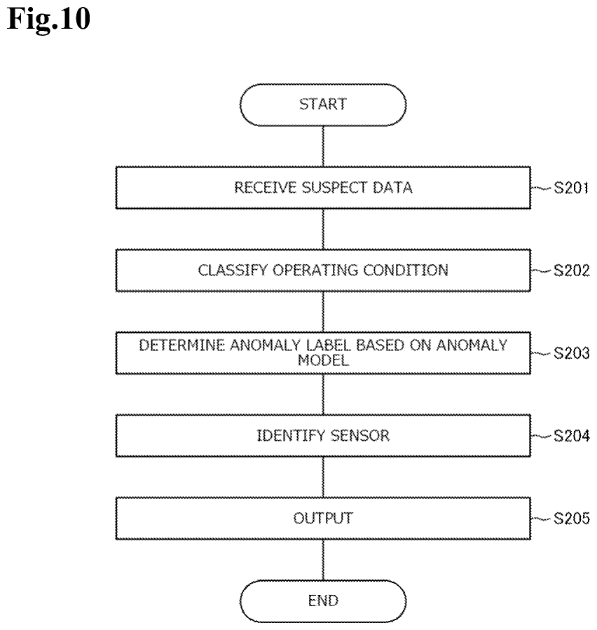

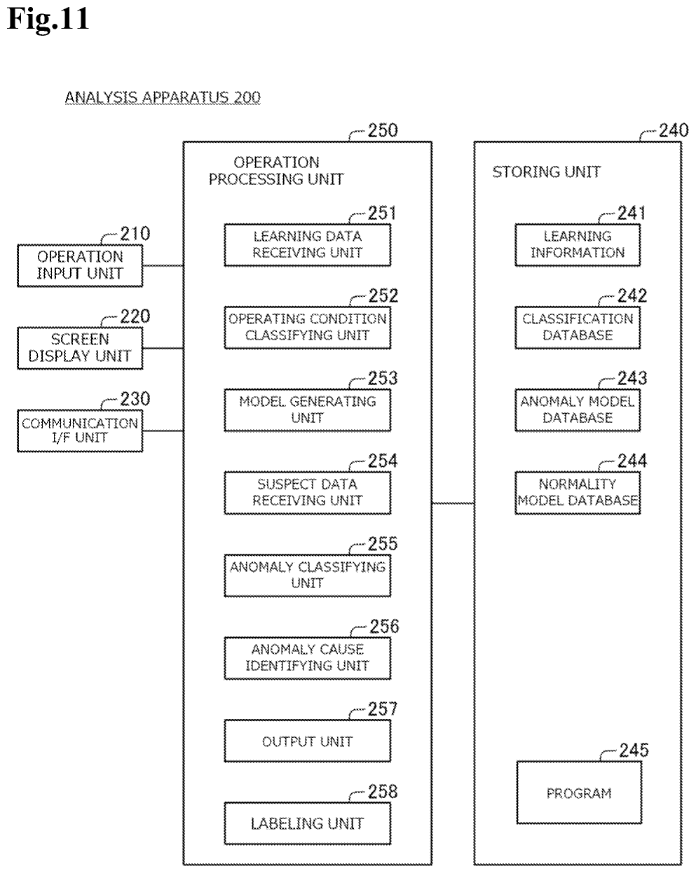

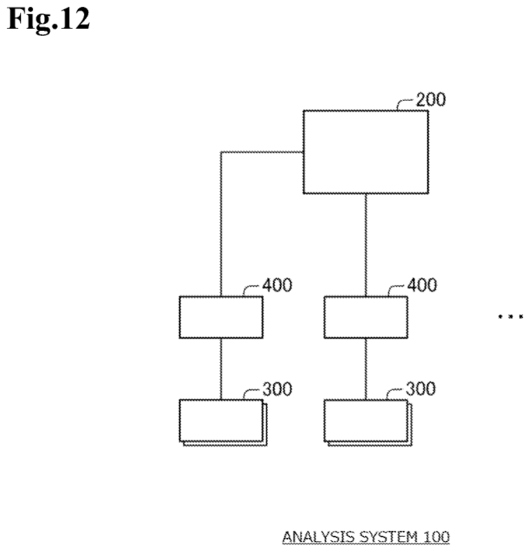

A first example embodiment of the present disclosure will be described with reference to FIGS. 1 to 12. FIG. 1 is a view showing a configuration example of an analysis system 100. FIG. 2 is a block diagram showing a configuration example of an analysis apparatus 200. FIG. 3 is a view showing an example of information included by learning information 241. FIG. 4 is a view showing an example of time-series data. FIG. 5 is a view showing an example of information included by anomaly model database 243. FIG. 6 is a view showing an example of normality model database 244. FIG. 7 is a view for describing an example of processing by a model generating unit 253. FIG. 8 is a view for describing an example of output by an output unit 257. FIG. 9 is a flowchart showing an example of operation of the analysis apparatus 200 at the time of learning. FIG. 10 is a flowchart showing an example of operation of the analysis apparatus 200 at the time of analyzing. FIG. 11 is a view showing another configuration example of the analysis apparatus 200. FIG. 12 is a view showing another configuration example of the analysis system 100.

The first example embodiment of the present disclosure describes an analysis system 100 that, based on suspect data, which is time-series sensing data acquired by a sensor 300 when some anomaly has occurred, classifies the type of the anomaly having occurred, such as bearing failure or engine noise. As will be described later, the analysis system 100 learns an anomaly model in advance based on sensing data to which an anomaly label indicating the type of anomaly is assigned. When receiving suspected data, the analysis system 100 classifies the type of anomaly based on the learned anomaly model.

Further, the analysis system 100 can identify a sensor 300 having detected information assumed to be the cause of the classified anomaly and sensing data based on the suspect data and information corresponding to past sensing data. For example, the analysis system 100 identifies the sensor 300 having detected information corresponding to the cause of the anomaly and so forth by comparing a feature value obtained by converting the suspect data with feature values included by the anomaly model or a normality model learned in advance and by comparing the suspect data with the past sensing data. A result identified by the analysis system 100 is reflected on the anomaly label and so forth, for example, and can thereby be used for update of the anomaly model. In other words, the analysis system 100 can learn a new anomaly model on which the identified result is reflected.

Further, the analysis system 100 described in this example embodiment classifies the type of an anomaly and identifies the sensor 300 having detected information corresponding to the cause of the anomaly and so forth based on suspect data acquired by a plurality of sensors 300 targeting an apparatus with a plurality of operating conditions, such as a vehicle. For example, the analysis system 100 may learn the anomaly model and the normality model for each operating condition. Meanwhile, when acquiring suspect data, the analysis system 100 may divide the suspect data for each operating condition and, based on the divided suspect data, classify the type of anomaly for each operating condition and identify a sensor having detected information corresponding to the cause of the anomaly.

In this example embodiment, the operating condition refers to those indicating conditions and states of a running condition and the like of a target apparatus, such as stop, low speed, high speed, right turn, left turn, and deceleration. However, the operating condition may vary with an apparatus to be an analysis target that the analysis system 100 analyzes, such as a vehicle. For example, the analysis target that the analysis system 100 analyzes may be an aircraft, an unmanned aircraft, a ship, a submarine and the like, and the operating condition may include conditions and states appropriate for the analysis target, such as those corresponding to flight condition, navigation condition, and diving condition. As will be described later, in this example embodiment, in accordance with the result of classification of the operating condition by an operating condition classifying unit 252, a condition label indicating operating condition can be assigned to time-series sensing data. The condition label may be automatically generated, automatically assigned from a dictionary, redefined by a person afterward, or the like.

Further, in this example embodiment, the anomaly label indicates anomaly types such as bearing failure and engine noise. The anomaly label may be, for example, determined during maintenance operation performed periodically or in response to detection of an anomaly. In other words, the anomaly label does not necessarily need to definitely indicate the cause of an anomaly, and may be, other than anomaly types, classifications corresponding to locations of failure and replacement parts, and abstract classifications such as anomaly of engine sound.

FIG. 1 shows a configuration example of the analysis system 100. Referring to FIG. 1, the analysis system 100 includes, for example, the analysis apparatus 200 and the plurality of sensors 300. In this example embodiment, the plurality of sensors 300 acquire sensing data corresponding to the running of a vehicle having a plurality of operating conditions. For example, the sensors 300 may include a sensor that detects the speed of the vehicle, a sensor that detects turning on and off of an engine, a sensor that detects the location of the vehicle, and the like. The plurality of sensors 300 may be all included by the vehicle, or some may be installed outside the vehicle. As shown in FIG. 1, sensing data acquired by the sensor 300 can be transmitted to the analysis apparatus 200 via a network or the like.

The analysis apparatus 200 is an information processing apparatus that acquires sensing data acquired by the sensor 300 when some anomaly occurs as suspect data and classifies the type of the anomaly based on the acquired suspect data. Moreover, the analysis apparatus 200 can identify a sensor having detected information corresponding to the cause of the anomaly, sensing data, and so forth, based on the suspect data. FIG. 2 shows a major configuration example of the analysis apparatus 200. Referring to FIG. 2, the analysis apparatus 200 includes, as major components, an operation input unit 210, a screen display unit 220, a communication OF unit 230, a storing unit 240, and an operation processing unit 250, for example.

FIG. 2 illustrates a case of realizing a function as the analysis apparatus 200 by using one information processing apparatus. However, the analysis apparatus 200 may be realized by a plurality of information processing apparatuses, such as realized on the cloud. Moreover, the analysis apparatus 200 may not include part of the configuration illustrated above, for example, without the operation input unit 210 and the screen display unit 220, and may have a configuration other than illustrated above.

The operation input unit 210 is formed of operation input devices such as a keyboard and a mouse. The operation input unit 210 detects an operation of an operator operating the analysis apparatus 200, and outputs to the operation processing unit 250.

The screen display unit 220 is formed of a screen display device such as an LCD (Liquid Crystal Display). The screen display unit 220 can display on a screen a variety of information stored in the storing unit 240 and information corresponding to the result of processing by an anomaly classifying unit 255 and an anomaly cause identifying unit 256, in response to an instruction from the operation processing unit 250.

The communication I/F unit 230 includes a data communication circuit. The communication I/F unit 230 performs data communication with the sensor 300 and another external device connected via a communication line.

The storing unit 240 includes storage devices such as a hard disk and a memory. The storing unit 240 stores processing information necessary for a variety of processing in the operation processing unit 250 and a program 245. The program 245 is loaded and executed by the operation processing unit 250 to realize various processing units. The program 245 is loaded in advance from an external device or a recording medium via a data input/output function such as the communication I/F unit 230, and stored into the storing unit 240. Major information stored in the storing unit 240 includes, for example, learning information 241, classification database 242, anomaly model database 243, and normality model database 244.

The learning information 241 includes learning data such as sensing data used at the time of learning an anomaly model and a normality model. For example, the learning information 241 is updated when a learning data receiving unit 251, which will be described later, receives sensing data from the sensor 300 or another external device via the communication I/F unit 230. Moreover, the learning information 241 can be updated in accordance with the result of a classification process performed by the operating condition classifying unit 252, which will be described later.

FIG. 3 shows an example of the learning information 241. Referring to FIG. 3, the learning information 241 includes anomaly data used for learning an anomaly model and normality data used for learning a normality model.

The anomaly data includes sensing data with an anomaly label indicating the type of anomaly. For example, referring to FIG. 3, identification information, time-series data, an anomaly label, and secondary information are associated as anomaly data in the learning information 241. Here, the identification information is information for identifying the time-series data and so forth. The identification information may be any information given uniquely. The time-series data shows time-series sensing data acquired by the sensor 300 and the like. For example, referring to FIG. 4, the time-series data includes a plurality of sensing data. Moreover, to the time-series data, a condition label indicating the operating condition of the vehicle at time corresponding to the data can be assigned by the operating condition classifying unit 252, which will be described later. In other words, the time-series data may be divided by condition labels for the respective operating conditions. The secondary information includes information describing the associated time-series data, such as information representing the content of maintenance during maintenance operation and the content of replacement of a part. For example, the secondary information includes information indicating a part replaced due to an anomaly, information indicating the sensor 300 having detected information corresponding to the cause of an anomaly, and other information that can be given during maintenance such as various maintenance records. The secondary information may include any other information.

The normality data includes sensing data acquired by the sensor 300 and the like in a state where no anomaly has occurred. For example, referring to FIG. 3, identification information and time-series data are associated as normality data in the learning information 241. Here, the identification information is information for identifying the time-series data. The identification information may be any information given uniquely. The time-series data shows time-series sensing data acquired by the sensor 300 and the like. As in the case of the anomaly data, the time-series data may include a plurality of sensing data. Moreover, to the time-series data, a condition label indicating the operating condition of the vehicle at time corresponding to the sensing data can be assigned by the operating condition classifying unit 252, which will be described later. Also in the normality data, any secondary information and the like may be associated.

The classification database 242 includes information used when the operating condition classifying unit 252 classifies the operating condition based on the sensing data and so forth. For example, information included by the classification database 242 is acquired in advance from an external device and the like via the communication IN unit 230. The classification database 242 may be updated in accordance with the result of the classification process such as clustering performed by the operating condition classifying unit 252, for example.

For example, the classification database 242 can include a threshold value for classifying the operating condition based on one or any number of sensing data among the plurality of sensing data. For example, in a case where the operating condition classifying unit 252 classifies the operating condition based on sensing data acquired by the sensor 300 detecting the speed of the vehicle, the classification database 242 may include information in which the range of speed is associated with a condition label such as stop, low speed, and high speed. Any range and any type of condition label associated therewith included by the classification database 242 may be set. Moreover, the operating condition may be classified based on sensing data acquired by a plurality of sensors, such as the speed of the vehicle and the operating condition of the engine and, in such a case, a conditional label corresponding to the range of each sensing data may be associated in the classification database 242. Alternatively, for example, in a case where the operating condition classifying unit 252 classifies the operating condition using an unsupervised algorithm such as clustering on each time-series data (or a feature value obtained by converting the time-series data) included by the learning information 241, the classification database 242 may include information corresponding to the result of the classification process such as clustering mentioned above.

For example, as stated above, information for classifying the operating condition is stored in the classification database 242. As described above, information stored as the classification database 242 may be acquired in advance from an external device via the communication I/F unit 230 and the like, and may be updated in accordance with the result of processing by the operating condition classifying unit 252 and the like.

The anomaly model database 243 includes information for determining the type of anomaly such as an anomaly feature value, which is a feature value calculated based on time-series data included in anomaly data. For example, the anomaly model database 243 is updated in accordance with, for example, conversion of time-series data included by anomaly data into an anomaly feature value by a model generating unit to be described later performing known processing such as model-free analysis. The anomaly model database 243 may include a condition label assigned by the operating condition classifying unit 252.

FIG. 5 shows an example of information included by the anomaly model database 243. Referring to FIG. 5, for example, identification information, an anomaly feature value, and a condition label are associated in the anomaly model database 243. Here, the identification information is information for identifying a feature value and so forth. The identification information may be equivalent to identification information included in a feature value calculation source in the anomaly data. Moreover, the anomaly feature value is a value calculated based on the time-series data included by the anomaly data. For example, the anomaly feature value may be data in vector format. Moreover, the condition label may be the same as that assigned in the feature value calculation source in the anomaly data. Meanwhile, the anomaly model database 243 may include information other than the information illustrated above, such as an anomaly label associated in addition to the illustrated information.

The normality model database 244 includes information indicating a normal state such as a normality feature value, which is a feature value calculated based on time-series data included by normality data. For example, the normality model database 244 is updated in accordance with, for example, conversion of time-series data included by normality data into a normality feature value by the model generating unit 253 to be described later performing known processing such as model free analysis. The normality model database 244 may include a condition label assigned by the operating condition classifying unit 252.

FIG. 6 shows an example of information included by the normality model database 244. Referring to FIG. 6, for example, identification information, a normality feature value, and a condition label are associated in the normality model database 244. Here, the identification information is information for identifying a feature value and so forth. The identification information may be equivalent to identification information included in a feature value calculation source in the normality data. Moreover, the normality feature value is a value calculated based on the time-series data included in the normality data. For example, the normality feature value may be data in vector format. Moreover, the condition label may be the same as that assigned in the feature value calculation source in the normality data. Meanwhile, in the normality model database 244, information other than the illustrated above may be included.

The operation processing unit 250 has an arithmetic logic unit such as a CPU (Central Processing Unit) and a peripheral circuit thereof. The operation processing unit 250 loads the program 245 from the storing unit 240 and executes to make the abovementioned hardware and the program 245 cooperate with each other and realize various processing units. Major processing units realized by the operation processing unit 250 include, for example, a learning data receiving unit 251, an operating condition classifying unit 252, a model generating unit 253, a suspect data receiving unit 254, an anomaly classifying unit 255, an anomaly cause specifying unit 256, and an output unit 257.

The analysis apparatus 200 may have, instead of the abovementioned CPU, a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof.

The learning data receiving unit 251 receives sensing data acquired by the sensor 300 and another external device from the sensor 300 and the like. To the sensing data received by the learning data receiving unit 251, an anomaly label may be assigned. Moreover, the learning data receiving unit 251 stores the received sensing data as the learning information 241 into the storing unit 240. For example, the learning data receiving unit 251 can store sensing data with an anomaly label as anomaly data into the storing unit 240 and also store sensing data without an anomaly label as normality data into the storing unit 240. The learning data receiving unit 251 may receive sensing data and so forth together with information indicating anomaly data or normality data.

The learning data receiving unit 251 may receive any secondary information and so forth together with the sensing data and so forth. The learning data receiving unit 251 can store the received secondary information and so forth as the learning information 241 into the storing unit 240.

The operating condition classifying unit 252 classifies the operating condition of the vehicle at each time on time-series data included by the learning information 241. For example, the operating condition classifying unit 252 can classify the operating condition based on one or any number of sensing data among a plurality of sensing data included by time-series data, using a threshold value and the like included in the classification database 242. The operating condition classifying unit 252 may classify the operating condition in accordance with the result of the classification process such as clustering. Moreover, the operating condition classifying unit 252 can store information such as a clustering model according to the result of the classification as the classification database 242 into the storing unit 240.

For example, the operating condition classifying unit 252 can classify the operating condition at each time in time-series data based on sensing data acquired by the sensor 300 detecting the speed of the vehicle among a plurality of sensing data included by time-series data and based on the threshold value included by the classification database 242. Moreover, the operating condition classifying unit 252 can assign a condition label corresponding to the classification result to the time-series data in accordance with the result of the classification above. By the classification of the operating condition by the operating condition classifying unit 252, time-series sensing data is divided into a plurality of sections corresponding the operating conditions as illustrated in FIG. 4. Meanwhile, as described above, the operating condition classifying unit 252 may classify the operating condition based on sensing data acquired by the plurality of sensors 300, such as the speed of the vehicle and the operating condition of the engine.

Further, for example, the operating condition classifying unit 252 may classify the operating condition by executing an unsupervised clustering algorithm such as DBSCAN (Density-based spatial clustering of applications with noise) on each time-series data included in normality data and a normal feature value calculated from the time-series data. In this case, the operating condition classifying unit 252 may be configured to automatically assign provisional condition labels to the respective clusters obtained by classification. The provisional condition labels may be defined afterward at any timing by a person or the like. Moreover, the operating condition classifying unit 252 may classify, for example, each time-series data included in normality data using the result of the classification above. The operating condition classifying unit 252 may perform the above classification process using time-series data included in anomaly data, instead of the normality data or as well as the normality data.

For example, as described above, the operating condition classifying unit 252 classifies the operating condition of the vehicle on time-series data included in the learning information 241 and assigns a corresponding condition label. Moreover, the operating condition classifying unit 252 can classify suspect data received by the suspect data receiving unit 254 using the classification database 242. The operating condition classifying unit 252 may classify the operating condition in the suspect data by the same method as the abovementioned method.

The model generating unit 253 learns the anomaly model based on the anomaly data included by the learning information 241. Moreover, the model generating unit 253 learns the normality model based on the normality data included by the learning information 241. Meanwhile, the model generating unit 253 may learn the anomaly model and the normality model for each condition label classified by the operating condition classifying unit 252, or may learn the anomaly model and the normality model regardless of the condition label.

For example, the model generating unit 253 performs unsupervised model-free analysis on the time-series data included by the anomaly data and thereby converts the time-series data into an anomaly feature value, which is a feature value indicating an anomalous state, including data in vector form. For example, as shown in FIG. 7, the model generating unit 253 divides the time-series data into segment data based on any criterion and extracts, for each division segment data, a feature value according to temporal change and a feature value according to the relation between the sensors 300. The model generating unit 253 can then perform the conversion into the anomaly feature value described above by synthesizing the extracted feature values. The process of extracting the feature value according to temporal change and the feature value according to the relation between the sensors 300 may be realized by, for example, machine learning using deep learning. The model generating unit 253 stores the generated anomaly feature values as the anomaly model database 243 into the storing unit 240.

As described above, the model generating unit 253 may calculate an anomaly feature value for each condition label based on time-series data divided for each condition label. The model generating unit 253 may associate an anomaly feature value with a condition label assigned to time-series data from which the anomaly feature value has been calculated in the anomaly model database 243.

Further, for example, the model generating unit 253 performs unsupervised model-free analysis on the time-series data included by the normality data and thereby converts the time-series data into a normality feature value, which is a feature value indicating a normal state, including data in vector form. As in the case of generating the anomaly model, the model generating unit 253 may extract, for each segment data obtained by dividing the time-series data, a feature value according a temporal change and a feature value according to the relation between the sensors 300, and perform the conversion into the abovementioned normality feature value by synthesizing the extracted feature values. Moreover, the model generating unit 253 stores the generated normality feature values as the normality model database 244 into the storing unit 240. As in the case of generating the anomaly model, the model generating unit 253 may calculate the normality feature value for each condition label based on the time-series data divided for each condition model. Moreover, the model generating unit 253 may associate the normality feature value with a condition label assigned to the time-series data from which the normality feature value has been calculated.

For example, as described above, the model generating unit 253 can learn the anomaly model and the normality model based on the learning information 241. The model generating unit 253 may learn the models by a method other than the illustrated above. For example, the model generating unit 253 may perform machine learning by using another machine learning model that can express a behavior in normality such as invariant analysis in generation of the normality model.

The suspect data receiving unit 254 receives sensing data acquired by the sensor 300 when any anomaly occurs as suspect data. In other words, the suspect data receiving unit 254 receives sensing data around time when an anomaly has been recognized by any external means or the like, as suspect data from the sensor 300 or another external device. As described above, to suspect data received by the suspect data receiving unit 254, a condition label can be assigned by the operating condition classifying unit 252. In other words, the suspect data received by the suspect data receiving unit 254 can be divided for each operating condition by the operating condition classifying unit 252.

The anomaly classifying unit 255 classifies the type of an anomaly having occurred based on suspect data received by the suspect data receiving unit 254. The anomaly classifying unit 255 may classify the type of anomaly for each operating condition, or may classify the type of anomaly regardless of operating condition.

For example, the anomaly classifying unit 255 performs unsupervised model-free analysis on suspect data to convert the suspect data into a feature value formed of data in vector format and so forth. Moreover, the anomaly classifying unit 255 compares the feature value obtained by the conversion with the anomaly feature values included by the anomaly model database 243. Then, the anomaly classifying unit 255 identifies an anomaly feature value which is the most similar to the feature value obtained by the conversion among the anomaly feature values included by the anomaly model database 243, and identifies an anomaly label associated with time-series data from which the identified anomaly feature value has been calculated in the anomaly data.

For example, as described above, the anomaly classifying unit 255 compares a feature value obtained by conversion from suspect data with the anomaly feature values included by the anomaly model database 243, and thereby identify an anomaly label indicating the type of anomaly corresponding to the suspect data. The anomaly classifying unit 255 may identify a similar feature value by any means, for example, using cosine similarity. Moreover, the anomaly classifying unit 255 may identify related secondary information along with the anomaly label. For example, as stated above, the secondary information can include information indicating the sensor 300 having detected information corresponding to the cause of anomaly. Therefore, the anomaly classifying unit 255 may identify, along with the anomaly label, information indicating the sensor 300 having detected information corresponding the cause of anomaly, determined in the past.

As stated above, the anomaly classifying unit 255 may identify an anomaly label indicating the type of anomaly for each operating condition. In the case of identifying an anomaly label for each operating condition, the anomaly classifying unit 255 may perform conversion into a feature value for each operating condition. Moreover, the anomaly classifying unit 255 may compare the feature value obtained by the conversion with anomaly feature values associated with the corresponding condition labels in the anomaly model database 243, and thereby identify a similar anomaly feature value.

The anomaly cause identifying unit 256 identifies the sensor 300 having detected information assumed to be the cause of an anomaly classified by the anomaly classifying unit 255 and sensing data based on suspect data. For example, the anomaly cause identifying unit 256 compares a feature value obtained by conversion from the suspect data with the feature values included by the anomaly model and the normality model, and compares the suspect data with the past sensing data, and thereby identifies the sensor 300 having detected information corresponding to the cause of the anomaly, and so forth. In other words, the anomaly cause identifying unit 256 can identify the sensor 300 having detected information assumed to be the cause of an anomaly and sensing data based on the suspect data itself and information corresponding to the sensing data such as a feature value obtained by conversion from the suspect data and based on the feature values included by the anomaly model and the normality model and past data of the sensing data itself.

For example, the anomaly cause identifying unit 256 compares suspect data with time-series data included by normality data. Then, the anomaly cause identifying unit 256 identifies sensing data determined to be the most deviant from data in normality among a plurality of sensing data included by the suspect data, and thereby identifies that the sensor 300 corresponding to the identified sensing data has detected information corresponding to the cause of anomaly. The anomaly cause identifying unit 256 may determine time-series data to be compared with the suspect data among the time-series data included by the normality data by any means. Moreover, the anomaly cause identifying unit 256 may determine whether or not to be deviant from data in normality by any means. For example, the anomaly cause identifying unit 256 may determine whether or not to be deviant from data in normality by calculating the distance between corresponding sensing data in the suspect data and the time-series data.

Further, the anomaly cause identifying unit 256 may identify the sensor 300 having detected information assumed to be the cause of anomaly and sensing data based on the result of comparison between the suspect data and the time-series data included by the anomaly data. For example, the anomaly cause identifying unit 256 can identify sensing data determined to be the most similar to anomaly as a result of comparison and thereby identify that the sensor 300 corresponding to the identified sensing data has detected information corresponding to the cause of anomaly. The anomaly cause identifying unit 256 may determine time-series data to be compared with the suspect data among the time-series data included by the anomaly data by any means. For example, the anomaly cause identifying unit 256 may determine, as the target of comparison, one selected by any means among the time-series data with which the same anomaly label as the anomaly label identified by the anomaly classifying unit 255 is associated among the anomaly data. Moreover, the anomaly cause identifying unit 256 may determine whether or not to be similar to anomaly by known means.

Further, the anomaly cause identifying unit 256 may compare an feature value obtained by conversion from the suspect data with the feature values included by the anomaly model or the normality model, and thereby identify sensing data that is deviant from data in normality or that is similar to data in anomaly. In other words, the anomaly cause identifying unit 256 may perform identification of sensing data mentioned above based on the result of comparison of data in vector format obtained by conversion from the suspect data with data in vector format included by the anomaly model and the normality model.

For example, as stated above, the anomaly cause identifying unit 256 can identify the sensor 300 having detected information assumed to be the cause of an anomaly classified by the anomaly classifying unit 255 and sensing data based on the suspect data.

In a case where the anomaly classifying unit 255 identifies, along with an anomaly label, information indicating the sensor 300 having detected information corresponding to the cause of an anomaly, the anomaly cause identifying unit 256 may be configured to compare the result of identification by the anomaly classifying unit 255 with the result of identification by the anomaly cause identifying unit 256. Moreover, for example, the anomaly cause identifying unit 256 can determine whether or not the sensor 300 identified by the anomaly classifying unit 255 is the same as the sensor 300 identified by the anomaly cause identifying unit 256 as a result of the comparison. For example, in a case where the sensor 300 identified by the anomaly classifying unit 255 is different from the sensor 300 identified by the anomaly cause identifying unit 256, the anomaly cause identifying unit 256 may output information indicating detection of information that the sensor 300 that is different from the sensor 300 identified based on the past result is the cause.

The output unit 257 outputs the type of an anomaly and an anomaly label identified by the anomaly classifying unit 255, the sensor 300 having detected information assumed to be the cause of the anomaly and sensing data identified by the anomaly cause identifying unit 256, information corresponding to the result of comparison by the anomaly cause identifying unit 256, and so forth. For example, the output unit 257 can display the information described above on the screen display unit 220 and transmit to an external device via the communication I/F unit 230. The output unit 257 may output identified secondary information and so forth, in addition to the abovementioned information.

For example, FIG. 8 shows an example of the output by the output unit 257. As illustrated in FIG. 8, the output unit 257 can output information indicating the type of a failure and the failure site identified based on an anomaly label identified by the anomaly classifying unit 255. The output unit 257 can also output, in addition to the above information, the sensor 300 and sensing data identified by the anomaly cause identifying unit 256. The output unit 257 may output, in addition to the above information, secondary information such as maintenance records.

The above is an example of the configuration of the analysis apparatus 200. Next, with reference to FIGS. 9 and 10, an example of operation of the analysis apparatus 200 will be described. First, with reference to FIG. 9, an example of operation of the analysis apparatus 200 in learning an anomaly model and a normality model will be described. Referring to FIG. 9, the operating condition classifying unit 252 classifies the operating condition of the vehicle at each corresponding time to the time-series data included by the learning information 241 (step S101). For example, the operating condition classifying unit 252 classifies the operating condition based on one or any number of sensing data among a plurality of sensing data included by the time-series data, using a threshold value included by the classification database 242. The operating condition classifying unit 252 may classify the operating condition by performing a classification process such as clustering.

The model generating unit 253 leans an anomaly model based on the anomaly data included by the learning information 241 (step S102). The model generating unit 253 may learn an anomaly model for each condition label obtained by classification by the operating condition classifying unit 252, or may learn an anomaly model regardless of condition label.

Further, the model generating unit 253 learns a normality model based on the normality data included by the learning information 241 (step S103). The model generating unit 253 may learn a normality model for each condition label obtained by classification by the operating condition classifying unit 252, or may learn a normality model regardless of condition label.

The above is an example of the operation in learning a model. The process at step S102 and the process at step S103 may be performed either first or may be performed in parallel.

Subsequently, with reference to FIG. 10, an example of operation of the analysis apparatus 200 in receiving suspect data will be described. Referring to FIG. 10, the suspect data receiving unit 254 receives, as suspect data, sensing data acquired by the sensor 300 when any anomaly occurs (step S201).

The operating condition classifying unit 252 classifies an operating condition in the suspect data based on the classification database 242. In other words, the operating condition classifying unit 252 can perform an operating condition classification process and thereby divide the suspect data for each operation condition (step S202).

The anomaly classifying unit 255 classifies the type of the anomaly having occurred based on the suspect data (step S203). For example, the anomaly classifying unit 255 performs unsupervised model-free analysis on the suspect data and thereby converts the suspect data into a feature value formed of data in vector format. Moreover, the anomaly classifying unit 255 compares the feature value obtained by the conversion with the anomaly feature values included by the anomaly model database 243. Then, the anomaly classifying unit 255 identifies an anomaly feature value that is the most similar to the feature value obtained by the conversion among the anomaly feature values included by the anomaly model database 243, and identifies an anomaly label in anomaly data from which the identified anomaly feature value has been calculated. The anomaly classifying unit 255 may classify the type of anomaly for each operating condition or may classify the type of anomaly regardless of operating condition.

The anomaly cause identifying unit 256 identifies the sensor 300 having detected information assumed to be the cause of the anomaly classified by the anomaly classifying unit 255 and sensing data based on the suspect data (step S204). For example, the anomaly cause identifying unit 256 identifies the sensor 300 having detected information corresponding to the cause of the anomaly by comparing the feature value obtained by the conversion from the suspect data with the feature values included by the anomaly model and a previously learned normality model, and comparing the suspect data with the past sensing data.

The output unit 257 outputs the type of an anomaly and an anomaly label identified by the anomaly classifying unit 255, and the sensor 300 having detected information assumed to be the cause of the anomaly and sensing data identified by the anomaly cause identifying unit 256 (step S205). For example, the output unit 257 can display the abovementioned information on the screen display unit 220 and transmit to an external device via the communication I/F unit 230. The output unit 257 may output, other than the abovementioned information, identified secondary information and so forth.

The above is an example of the operation of the analysis apparatus 200 in receiving suspect data.

Thus, the analysis apparatus 200 has the anomaly classifying unit 255 and the anomaly cause identifying unit 256. With such a configuration, the anomaly cause identifying unit 256 can identify the sensor 300 having detected information assumed to be the cause of an anomaly classified by the anomaly classifying unit 255 and sensing data based on suspect data. As a result, it becomes possible to update the anomaly model and so forth based on the learning information 241 to which an anomaly label with the result of identification by the anomaly cause identifying unit 256 being reflected on is assigned, and it becomes possible to perform more proper learning. That is to say, with the above configuration, it becomes possible to perform more appropriate assignment of an anomaly label with the sensor 300 having detected information corresponding to the cause of an anomaly being identified.

Further, the analysis apparatus 200 can identify the sensor 300 and the like for each operating condition. As a result, it becomes possible to perform more appropriate determination, and it becomes possible to perform more appropriate assignment of an anomaly label.

The configuration of the analysis apparatus 200 is not limited to the case illustrated in this example embodiment. For example, FIG. 11 shows an example of another configuration of the analysis apparatus 200. Referring to FIG. 11, the operation processing unit 250 of the analysis apparatus 200 can have a labeling unit 258 in addition to the configuration illustrated in FIG. 2 by loading and executing the program 245.

The labeling unit 258 assigns, for suspect data, an anomaly label to which information about the sensor 300 identified by the anomaly cause identifying unit 256 is added, and updates the learning information 241. Moreover, the labeling unit 258 can perform update of the anomaly model database 243 based on a feature value obtained by conversion of the suspect data.

The labeling unit 258 may be configured to, when the anomaly cause identifying unit 256 outputs information indicating that a different sensor 300 from the sensor 300 identified based on the past result has detected information of the cause, assign an anomaly label and update the anomaly model database.

Thus, the analysis apparatus 200 may have the labeling unit 258. With the labeling unit 258, the analysis apparatus 200 can automatically perform update of an anomaly model with the result of identification by the anomaly cause identifying unit 256 being reflected on.

Further, in this example embodiment, with reference to FIG. 1, the analysis system 100 has the analysis apparatus 200 and the plurality of sensors 300. For example, the analysis system 100 may have any information processing apparatus 400 connected to the plurality of sensors 300 as illustrated in FIG. 12. In this case, the analysis apparatus 200 may receive sensing data and so forth from the sensor 300 via the information processing apparatus 400. Moreover, as shown in FIG. 12, the analysis system 100 may have a plurality of information processing apparatuses 400 placed in different locations, for example.

### Second Example Embodiment

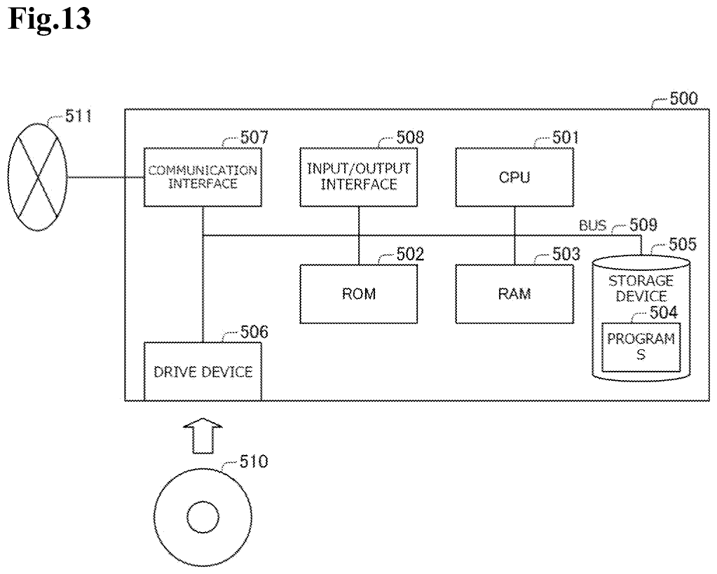

In a second example embodiment of the present disclosure, an example of a configuration of an analysis apparatus 500, which is an information processing apparatus that classifies the type of an anomaly based on time-series sensing data and also identifies a sensor having detected information corresponding to the cause of the anomaly will be described. FIG. 13 shows an example of a hardware configuration of the analysis apparatus 500. Referring to FIG. 13, as an example, the analysis apparatus 500 has the following hardware configuration including;
a CPU (Central Processing Unit) 501 (arithmetic logic unit),
a ROM (Read Only Memory) 502 (memory unit),
a RAM (Random Access Memory) 503 (memory unit),
programs 504 loaded to the RAM 503,
a storage device 505 storing the programs 504,
a drive device 506 reading from and writing into a recording medium 510 outside the information processing apparatus,
a communication interface 507 connected to a communication network 511 outside the information processing apparatus,
an input/output interface 508 inputting and outputting data, and
a bus 509 connecting the components.

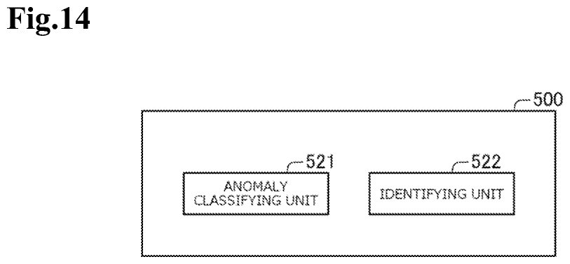

Further, the analysis apparatus 500 can realize functions as an anomaly classifying unit 521 and an identifying unit 522 shown in FIG. 14 by acquisition and execution of the programs 504 by the CPU 501. The programs 504 are, for example, stored in the storage device 505 and the ROM 502 in advance, and are loaded to the RAM 503 and the like and executed by the CPU 501 as necessary. Moreover, the programs 504 may be supplied to the CPU 501 via the communication network 511, or may be stored in the recording medium 510 in advance and retrieved and supplied to the CPU 501 by the drive device 506.

FIG. 13 shows an example of the hardware configuration of the analysis apparatus 500. The hardware configuration of the analysis apparatus 500 is not limited to the abovementioned case. For example, the analysis apparatus 500 may be configured by part of the abovementioned configuration, such as without the drive device 506.

The anomaly classifying unit 521 classifies the type of an anomaly having occurred based on time-series sensing data at the time of occurrence of the anomaly received from a plurality of sensors and a learned model learned in advance.

The identifying unit 522 identifies a sensor having detected information corresponding to the cause of the anomaly classified by the anomaly classifying unit 521 based on information corresponding to the sensing data and information corresponding to past data, which is past sensing data stored in advance.

Thus, the analysis apparatus 500 has the anomaly classifying unit 521 and the identifying unit 522. With such a configuration, the identifying unit 522 can identify a sensor having detected information corresponding to the cause of an anomaly classified by the anomaly classifying unit 521. As a result, it becomes possible to assign a label on which a result of identification by the identifying unit 522 is reflected, and it becomes possible to perform more appropriate learning.

The abovementioned analysis apparatus 500 can be realized by installation of a predetermined program in an information processing apparatus such as the analysis apparatus 500. Specifically, a program as another aspect of the present invention is a program for causing an information processing apparatus such as the analysis apparatus 500 to realize processes to classify the type of an anomaly having occurred based on time-series sensing data at the time of occurrence of the anomaly received from a plurality of sensors and a learned model learned in advance, and identify a sensor having detected information corresponding to the cause of the classified anomaly based on information corresponding to the sensing data and information corresponding to past data, which is past sensing data stored in advance.

Further, an analysis method executed by an information processing apparatus such as the analysis apparatus 500 described above is a method that is executed by the information processing apparatus such as the analysis apparatus 500 and includes classifying the type of an anomaly having occurred based on time-series sensing data at the time of occurrence of the anomaly received from a plurality of sensors and a learned model learned in advance, and identifying a sensor having detected information corresponding to the cause of the classified anomaly based on information corresponding to the sensing data and information corresponding to past data, which is past sensing data stored in advance.

The invention of a program, a computer-readable recording medium with the program recorded thereon, or an analysis method having the abovementioned configurations has the same actions and effects as those of the abovementioned analysis apparatus 500, and therefore, can achieve the object of the present invention.

### <Supplementary Notes>

The whole or part of the example embodiments disclosed above can be described as the following supplementary notes. Below, the overview of an analysis apparatus and others according to the present invention will be described. However, the present invention is not limited to the following configurations.

### (Supplementary Note 1)

An analysis apparatus comprising:
at least one memory configured to store instructions; and
at least one processor configured to execute the instructions to:
classify a type of an anomaly having occurred based on time-series sensing data in occurrence of anomaly received from a plurality of sensors and a learned model learned in advance; and
identify a sensor having detected information corresponding to a cause of the classified anomaly based on information corresponding to the sensing data and information corresponding to past data that is past sensing data stored in advance.

### (Supplementary Note 2)

The analysis apparatus according to Supplementary Note 1, wherein:
the past data includes information corresponding to past sensing data in normality; and
the at least one processor is configured to execute the instructions to check a state of deviation from the information corresponding to the past sensing data in normality of the information corresponding to the sensing data, and thereby identify the sensor having detected the information corresponding to the cause of the anomaly.

### (Supplementary Note 3)

The analysis apparatus according to Supplementary Note 1, wherein:
the past data includes information corresponding to past sensing data in occurrence of anomaly; and
the at least one processor is configured to execute the instructions to check a state of similarity of the information corresponding to the sensing data to the information corresponding to the past sensing data in occurrence of anomaly, and thereby identify the sensor having detected the information corresponding to the cause of the anomaly.

### (Supplementary Note 4)

The analysis apparatus according to Supplementary Note 1, wherein
the at least one processor is configured to execute the instructions to compare the sensing data with the past sensing data, and thereby identify the sensor having detected the information corresponding to the cause of the classified anomaly.

### (Supplementary Note 5)

The analysis apparatus according to Supplementary Note 1, wherein
the at least one processor is configured to execute the instructions to compare a feature value obtained by conversion of the sensing data with a normality feature value obtained by conversion of the past sensing data in normality, and thereby identify the sensor having detected the information corresponding to the cause of the classified anomaly.

### (Supplementary Note 6)

The analysis apparatus according to Supplementary Note 1, wherein the at least one processor is configured to:
execute the instructions to classify the type of the anomaly having occurred, and also identify information indicating the sensor having detected the information corresponding to the cause of the anomaly; and
compare the identified sensor with a sensor indicated by the identified information, and output information corresponding to a result of the comparison.

### (Supplementary Note 7)

The analysis apparatus according to Supplementary Note 6, wherein
the at least one processor is configured to assign a new label to the time-series sensing data in occurrence of anomaly in a case where the identified sensor is different from the sensor indicated by the identified information.

### (Supplementary Note 8)

The analysis apparatus according to Supplementary Note 1, wherein the at least one processor is configured to:
classify an operating condition based on the time-series sensing data in occurrence of anomaly received from the plurality of sensors; and
classify the type of the anomaly having occurred based on a result of the classification and a learned model learned for each operating condition.

### (Supplementary Note 9)

A non-transitory computer-readable recording medium having a program recorded thereon, the program comprising instructions for causing an information processing apparatus to realize processes to:
classify a type of an anomaly having occurred based on time-series sensing data in occurrence of anomaly received from a plurality of sensors and a learned model learned in advance; and
identify a sensor having detected information corresponding to a cause of the classified anomaly based on information corresponding to the sensing data and information corresponding to past data that is past sensing data stored in advance.

### (Supplementary Note 10)

An analysis method executed by an information processing apparatus, the analysis method comprising:
classifying a type of an anomaly having occurred based on time-series sensing data in occurrence of anomaly received from a plurality of sensors and a learned model learned in advance; and
identifying a sensor having detected information corresponding to a cause of the classified anomaly based on information corresponding to the sensing data and information corresponding to past data that is past sensing data stored in advance.

Thus, although the present invention has been described with reference to the above example embodiments, the present invention is not limited to the example embodiments described above. The configurations and details of the present invention can be changed in various manners that can be understood by one skilled in the art within the scope of the present invention.

### DESCRIPTION OF NUMERALS

100 analysis system
200 analysis apparatus
210 operation input unit
220 screen display unit
230 communication IN unit
240 storing unit
241 learning information
242 classification database
243 anomaly model database
244 normality model database
245 program
250 operation processing unit
251 learning data receiving unit
252 operating condition classifying unit
253 model generating unit
254 suspect data receiving unit
255 anomaly classifying unit
256 anomaly cause identifying unit
257 output unit
258 labeling unit
300 sensor
400 information processing apparatus
500 analysis apparatus
501 CPU
502 ROM
503 RAM
504 programs
505 storage device
506 drive device
507 communication interface
508 input/output interface
509 bus
510 recording medium
511 communication network
521 anomaly classifying unit
522 identifying unit

1. An analysis apparatus comprising:
at least one memory configured to store instructions; and
at least one processor configured to execute the instructions to:
classify a type of an anomaly having occurred based on time-series sensing data in occurrence of anomaly received from a plurality of sensors and a learned model learned in advance; and
identify a sensor having detected information corresponding to a cause of the classified anomaly based on information corresponding to the sensing data and information corresponding to past data that is past sensing data stored in advance.

2. The analysis apparatus according to claim 1, wherein:
the past data includes information corresponding to past sensing data in normality; and
the at least one processor is configured to execute the instructions to check a state of deviation from the information corresponding to the past sensing data in normality of the information corresponding to the sensing data, and thereby identify the sensor having detected the information corresponding to the cause of the anomaly.

3. The analysis apparatus according to claim 1, wherein:
the past data includes information corresponding to past sensing data in occurrence of anomaly; and
the at least one processor is configured to execute the instructions to check a state of similarity of the information corresponding to the sensing data to the information corresponding to the past sensing data in occurrence of anomaly, and thereby identify the sensor having detected the information corresponding to the cause of the anomaly.

4. The analysis apparatus according to claim 1, wherein
the at least one processor is configured to execute the instructions to compare the sensing data with the past sensing data, and thereby identify the sensor having detected the information corresponding to the cause of the classified anomaly.

5. The analysis apparatus according to claim 1, wherein
the at least one processor is configured to execute the instructions to compare a feature value obtained by conversion of the sensing data with a normality feature value obtained by conversion of the past sensing data in normality, and thereby identify the sensor having detected the information corresponding to the cause of the classified anomaly.

6. The analysis apparatus according to claim 1, wherein the at least one processor is configured to:
execute the instructions to classify the type of the anomaly having occurred, and also identify information indicating the sensor having detected the information corresponding to the cause of the anomaly; and
compare the identified sensor with a sensor indicated by the identified information, and output information corresponding to a result of the comparison.

7. The analysis apparatus according to claim 6, wherein
the at least one processor is configured to assign a new label to the time-series sensing data in occurrence of anomaly in a case where the identified sensor is different from the sensor indicated by the identified information.

8. The analysis apparatus according to claim 1, wherein the at least one processor is configured to:
classify an operating condition based on the time-series sensing data in occurrence of anomaly received from the plurality of sensors; and
classify the type of the anomaly having occurred based on a result of the classification and a learned model learned for each operating condition.

9. A non-transitory computer-readable recording medium having a program recorded thereon, the program comprising instructions for causing an information processing apparatus to realize processes to:
classify a type of an anomaly having occurred based on time-series sensing data in occurrence of anomaly received from a plurality of sensors and a learned model learned in advance; and
identify a sensor having detected information corresponding to a cause of the classified anomaly based on information corresponding to the sensing data and information corresponding to past data that is past sensing data stored in advance.

10. An analysis method executed by an information processing apparatus, the analysis method comprising:
classifying a type of an anomaly having occurred based on time-series sensing data in occurrence of anomaly received from a plurality of sensors and a learned model learned in advance; and
identifying a sensor having detected information corresponding to a cause of the classified anomaly based on information corresponding to the sensing data and information corresponding to past data that is past sensing data stored in advance.
